(19) United States
(12) Patent Application Publication
(10) Pub. No.: US 2012/0259778 A1
(43) Pub. Date: Oct. 11, 2012

(54) VIRTUAL ATM

(75) Inventors: Amlan Banerjee, Charlotte, NC (US); Therese H. Willis, Apopka, FL (US)

(73) Assignee: BANK OF AMERICA CORPORATION, Charlotte, NC (US)

(21) Appl. No.: 13/083,310

(22) Filed: Apr. 8, 2011

(51) Int. Cl. G06Q 40/00

(52) U.S. Cl. 705/43

(57) ABSTRACT

Embodiments of the present invention relate to systems, methods and computer program products for processing transaction information associated with a mobile banking transaction. In some embodiments, a method includes: (a) receiving transaction information associated with a mobile banking transaction, where the mobile banking transaction is performed using a mobile device; (b) determining, based at least partially on the transaction information, that the mobile device is positioned at a particular location during the transaction; (c) determining, using a processor, that the particular location is associated with a virtual ATM; (d) designating the transaction for processing in accordance with one or more rules associated with the virtual ATM; and/or (e) processing the transaction based at least partially on the transaction information and in accordance with one or more rules associated with the virtual ATM. In some of these embodiments, the mobile banking transaction is a mobile deposit transaction.

### BACKGROUND

Today, most financial institutions require their customers to visit traditional deposit locations, such as banking centers, automated teller machines (ATMs), and the like in order to make deposits and conduct other conventional ATM transactions. However, traveling to and from a traditional deposit location is sometimes viewed by financial institution customers as unnecessary, burdensome, and time-consuming. Thus, there is a need to provide methods and apparatuses that enable financial institution customers to engage in deposit transactions and other types of ATM and/or banking transactions in ways that are easier, more efficient, and less costly than the ways disclosed in the prior art.

### BRIEF SUMMARY OF SOME EMBODIMENTS OF THE PRESENT INVENTION

The following presents a simplified summary of several embodiments of the invention in order to provide a basic understanding of such embodiments. This summary is not an extensive overview of all contemplated embodiments of the invention. This summary is not intended to identify key or critical elements of all embodiments or to delineate the scope of any or all embodiments. Instead, its purpose is to present some concepts of one or more embodiments of the present invention in a simplified form as a prelude to the more detailed description that is presented later.

Embodiments of the present invention address the above needs and/or achieve other advantages by providing apparatuses (e.g., a system, computer program product, and/or other device) and methods configured to process mobile banking transactions. For instance, in some embodiments, a method is provided for processing transaction information associated with a mobile banking transaction. In such embodiments, the method includes: (a) receiving transaction information associated with a mobile banking transaction, where the mobile banking transaction is performed using a mobile device; (b) determining, based at least partially on the transaction information, that the mobile device is positioned at a particular location during the transaction; (c) determining, using a processor, that the particular location is associated with a virtual ATM; (d) designating the transaction for processing in accordance with one or more rules associated with the virtual ATM; and/or (e) processing the transaction based at least partially on the transaction information and in accordance with one or more rules associated with the virtual ATM.

### BRIEF DESCRIPTION OF THE DRAWINGS

Having thus described embodiments of the invention in general terms, reference will now be made to the accompanying drawings, where:

FIG. 1 is a flowchart illustrating a general process flow for processing a mobile banking transaction, in accordance with embodiments of the present invention;

FIG. 2 is a flowchart illustrating a general process flow for processing transaction a mobile deposit transaction, in accordance with embodiments of the present invention;

FIG. 3 is a block diagram illustrating a system for processing mobile banking transactions, in accordance with embodiments of the present invention; and

FIG. 4 is an exemplary map of the United States that illustrates how virtual ATMs may be associated with various locations on the map, in accordance with embodiments of the present invention.

### DETAILED DESCRIPTION OF SOME EMBODIMENTS OF THE INVENTION

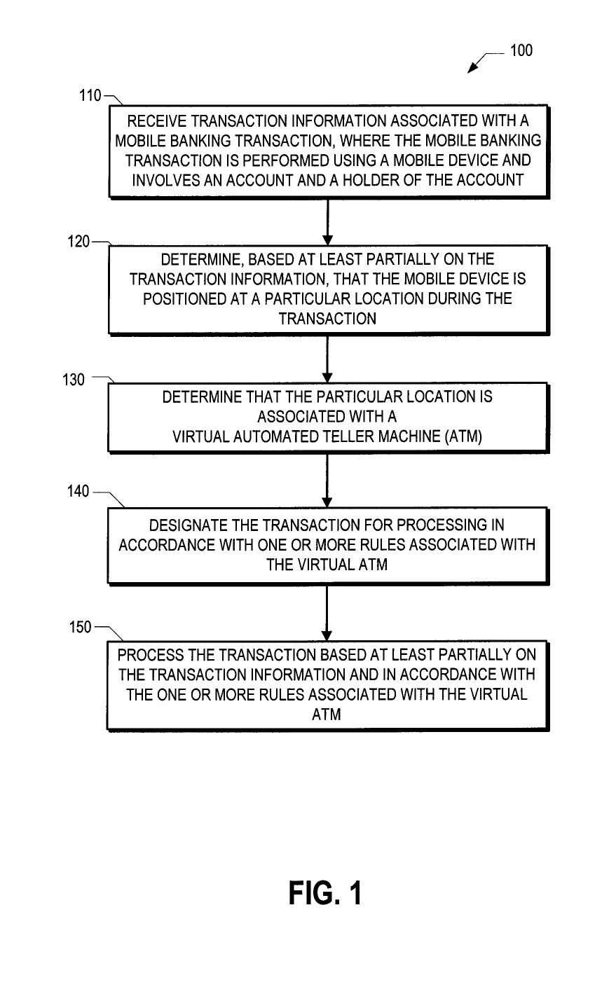

Referring now to FIG. 1, a general process flow 100 for processing a mobile banking transaction is provided, in accordance with an embodiment of the present invention. In some embodiments, the process flow 100 is performed by an apparatus having hardware and/or software configured to perform one or more portions of the process flow 100. In such embodiments, as represented by block 110, the apparatus is configured to receive transaction information associated with a mobile banking transaction, where the mobile banking transaction is performed using a mobile device (e.g., mobile phone, portable gaming device, mobile capture device, etc). As represented by block 120, the apparatus is also configured to determine, based at least partially on the transaction information, that the mobile device is positioned at a particular location during the transaction. As represented by block 130, the apparatus is further configured to determine that the particular location is associated with a virtual ATM. As represented by block 140, the apparatus is further configured to designate the transaction for processing in accordance with one or more rules associated with the virtual ATM. In addition, as represented by block 150, the apparatus is configured to process the transaction based at least partially on the transaction information and in accordance with the one or more rules associated with the virtual ATM.

It will be understood that, in some embodiments, the term “determine” is meant to have its one or more ordinary meanings (i.e., its ordinary dictionary definition(s)), but in other embodiments, that term is additionally or alternatively meant to include the one or more ordinary meanings of one or more of the following terms: conclude, decide, identify, ascertain, find, discover, learn, verify, calculate, observe, read, and/or the like. Further, it will be understood that, in some embodiments, the phrase “based at least partially on” is meant to have its one or more ordinary meanings, but in other embodiments, that phrase is additionally or alternatively meant to include the one or more ordinary meanings of one or more of the following phrases: “in response to,” “upon or after,” “because of,” “as a result of,” “if,” “when,” and/or the like.

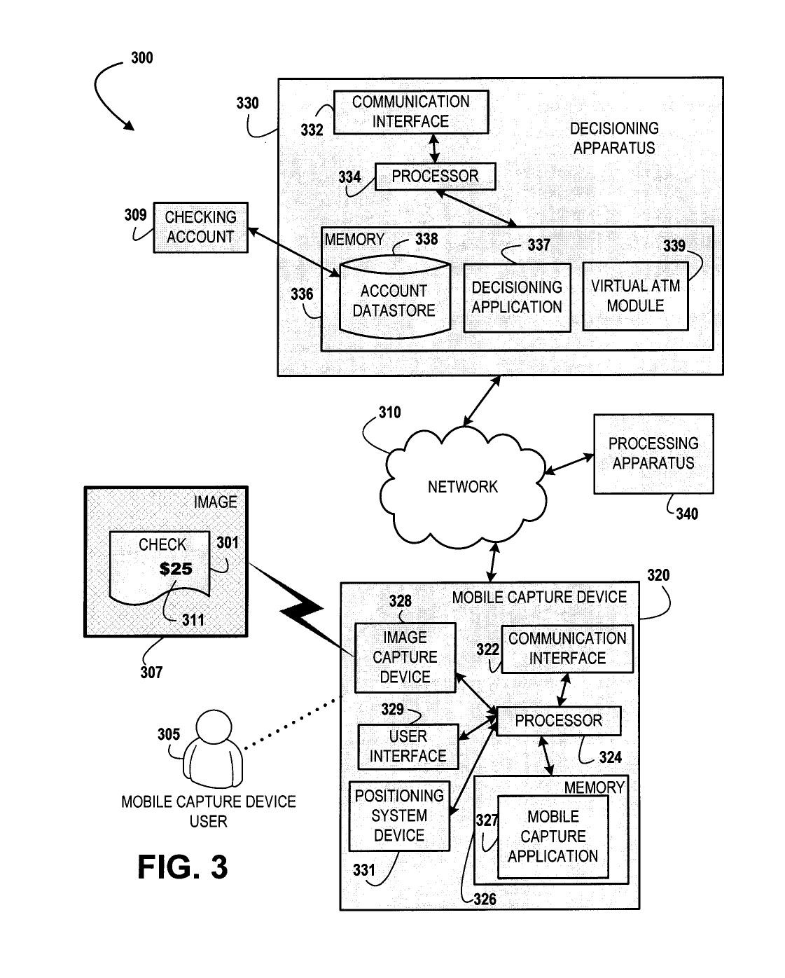

For simplicity, the portion of the process flow 100 represented by block 120 is sometimes referred to herein as the “position determination,” the portion represented by block 130 is sometimes referred to herein as the “virtual ATM determination,” and the portion represented by block 140 is sometimes referred to herein as the “transaction designation.” Also, it will be understood that the apparatus having the process flow 100 (and/or any of the apparatuses described and/or contemplated herein) can include one or more separate and/or different apparatuses. For example, in some embodiments, one apparatus (e.g., the decisioning apparatus 330 shown in FIG. 3, etc.) is configured to perform the portions of the process flow 100 represented by blocks 110-140, and a second apparatus (e.g., the processing apparatus 340) is configured to perform the portion represented by block 150. However, in other embodiments, a single apparatus is configured to perform each and every portion of the process flow 100. In addition, in some embodiments, a first portion of an apparatus is configured to perform one or more portions of the process flow 100, and one or more other portions of the same apparatus are configured to perform the one or more other portions of the process flow 100.

Regarding block 110, the mobile banking transaction can include any transaction involving a mobile device. Exemplary transactions include, but are not limited to: purchasing, renting, selling, and/or leasing one or more goods and/or services (e.g., merchandise, groceries, tickets, etc.); making mobile deposits; sending payments to creditors (e.g., paying bills, paying taxes, etc.); sending remittances; transferring funds; loading money onto stored value cards; and/or the like. In addition, the transaction information can be any information that identifies, defines, describes, and/or is otherwise associated with the transaction. Exemplary transaction information includes, but is not limited to, the party(ies) involved in the transaction, the date and/or time of the transaction, the account(s) involved in the transaction, the transaction amount(s) associated with the transaction, the good(s) and/or service(s) involved in the transaction, a description of the transaction (which, itself, can include any transaction information, e.g., the description may describe the transaction status, the goods and/or services involved in the transaction, etc.), and/or the like. In some embodiments, the transaction information additionally or alternatively includes information indicating whether a transaction amount associated with the transaction should be included in the available balance and/or daily ending balance for the account. In some embodiments, the transaction information additionally or alternatively includes information indicating when the transaction should post to the account.

The transaction information can also include any information that identifies, defines, describes, and/or is otherwise associated with the type of the transaction. As understood herein, the transaction type of a transaction may be defined, at least in part, by the one or more goods and/or services involved in the transaction (e.g., purchasing groceries, transferring funds, etc.), the one or more parties involved in the transaction (e.g., account holder, bank, teller, merchant, counterparty, etc.), when the transaction occurred (e.g., time of day, day of week, before or after the daily cutoff time, etc.), where the transaction occurred (e.g., GPS coordinates of the mobile device, information about the cell site in communication the mobile device during the transaction, etc.), and/or the like. In some embodiments, the transaction type is defined, at least in part, by the one or more channels through which the transaction is conducted, such as, for example, mobile device, electronic banking account (e.g., online banking account, mobile banking account, SMS banking account, etc.), call center, and/or the like. Additionally or alternatively, in some embodiments, the transaction type is defined, at least in part, by the one or more instruments and/or methods used to conduct the transaction, such as, for example, a debit card, credit card, checkcard, electronic check, wire transfer, online bill pay, automated clearing house (ACH), wireless and/or contactless payment, and/or the like.

The transaction type can also be defined, at least in part, by the status of the transaction, such as, for example, whether the transaction is and/or has been initiated, authorized, pending, held, delayed, posted, cleared, processed, finalized, reconciled, and/or the like. Of course, any given transaction may have more than one transaction type. For example, in accordance with some embodiments, a funds transfer transaction performed using a mobile device may be defined as a mobile device transaction, a mobile banking transaction, and/or a funds transfer transaction.

Further regarding block 110, the mobile device can include any number and/or type of mobile device(s). Examples of mobile devices include mobile phones (e.g., feature phones, smart phones, iPhones®, Droids®, etc.), mobile gaming devices (e.g., PlayStation Portable®, etc.), mobile computers (e.g., tablet computers, laptop computers, etc.), personal digital assistants (PDAs), and/or the like. In some embodiments, the mobile device is configured to send and/or receive communications (e.g., phone calls, text messages, actionable alerts, emails, social media-specific messages, etc.), present information via a user interface, play video games, and/or the like. In some embodiments, the mobile device is portable (e.g., not stationary) and/or can be carried and/or worn by and/or on a person.

In some embodiments, the mobile device is a mobile capture device and/or the mobile banking transaction is a mobile deposit transaction. The phrase “mobile capture device,” as used herein, refers to a mobile device that is configured to generate, create, acquire, receive, view, and/or capture one or more still images and/or videos (collectively referred to herein as “images” for simplicity). In some embodiments, the mobile capture device refers to an apparatus that houses one or more digital cameras, image sensors, lens, and/or other image capture devices. For example, in some embodiments, the mobile capture device refers to a mobile phone having a digital camera housed therein. However, in other embodiments, the mobile capture device refers to the image capture device itself. Referring to the example above, in accordance with some embodiments, the mobile capture device refers to the digital camera that is housed in the mobile phone. As a variation of this example, in still other embodiments, the mobile capture device refers to a digital camera that is not housed in the mobile phone, but is instead located adjacent, near, and/or otherwise proximate to the mobile phone (e.g., located within arm's reach of the mobile phone, etc.) and is operatively connected to (e.g., via wireline and/or wireless connection) the mobile phone. Thus, it will be understood that the mobile capture device can be embodied as an apparatus (e.g., a mobile phone that houses a digital camera, etc.), as a component of the apparatus (e.g., a digital camera housed in a mobile phone, etc.), or as a peripheral device associated with the apparatus (e.g., a digital camera operatively connected to and located proximately to a mobile phone, etc.). Additionally, in some embodiments, the phrase “mobile capture device” refers to a system having a mobile capture device and a peripheral image capture device operatively connected to the mobile capture device.

In some embodiments, where the mobile device is a mobile capture device and the mobile banking transaction is a mobile deposit transaction, the mobile capture device enables its user(s) to transform any location where the mobile capture device is located into a deposit location. It will also be understood that the mobile capture device (and/or mobile device) is typically owned, operated, serviced, held, carried, possessed, controlled, and/or maintained (collectively referred to herein as “maintained” for simplicity) by a customer of a financial institution, i.e., a user who holds an account that is maintained by the financial institution.

Examples of mobile capture devices include, but are not limited to, mobile phones (e.g., feature phones, smart phones, camera phones, etc.), cameras (e.g., digital cameras, video cameras, webcams, etc.), scanners (e.g., flatbed scanners, handheld scanners, etc.), personal digital assistants (PDAs), tablet computers (e.g., iPads®, etc.), gaming devices (e.g., Nintendo® DSi, Xbox 360® with Kinect sensor device, etc.), portable media players (e.g., iPods®, etc.), image capture devices (e.g., cameras, charge coupled devices (CCD), complementary metal-oxide-semiconductor (CMOS) sensors, other image sensors, etc.), as well as, in some embodiments, one or more components thereof and/or one or more peripheral devices associated therewith. Of course, it will be understood that, in some embodiments, the mobile capture device is configured to perform one or more other functions (e.g., sending and/or receiving one or more phone calls, text messages, and/or other communications, etc.) in addition to generating and/or capturing one or more images. In some embodiments, the mobile capture device refers to a wireless, portable, mobile, and/or handheld device, such as, for example, a handheld scanner and/or mobile phone. In some embodiments, the mobile capture device could also represent any remote computing device or electronic kiosk associated with a user.

Regarding block 120, the apparatus is configured to determine, based at least partially on the transaction information, that the mobile device is positioned at a particular location during the transaction. In some embodiments, the phrase “particular location” refers to a predetermined geographic area in which the mobile device is positioned during the transaction. In some embodiments, the apparatus is configured to make the position determination by determining the GPS coordinates of the mobile device during the mobile banking transaction. Additionally or alternatively, in some embodiments, the apparatus is configured to make the position determination by determining the location of one or more cell sites that are located near, and/or are in communication with, the mobile device during the transaction. As a further example, in some embodiments, the apparatus is configured to make the position determination based at least partially on one or more Internet Protocol (IP) and/or other network addresses associated with the mobile device during the transaction. Accordingly, the transaction information received by the apparatus may include GPS coordinates, information associated with cell sites, IP addresses and/or other network addresses, and/or other information that enables the apparatus to make the position determination.

Also, it will be understood that, in some embodiments, the phrase “during the transaction” refers to any one or more moments in time from when the transaction is initiated to when the transaction is completed (inclusive). For example, in some embodiments, where the mobile banking transaction includes a funds transfer, the phrase “during the transaction” includes the moment in time when the user of the mobile device initiates a mobile banking application and/or funds transfer tool necessary to perform the transaction on and/or using the mobile device. As another example, in some embodiments, where the mobile banking transaction includes a funds transfer, the phrase “during the transaction” includes to the moment in time when the user of the mobile device inputs the amount of a funds transfer into the mobile device. As another example, in some embodiments, where the mobile banking transaction includes a mobile deposit, the phrase “during the transaction” includes to the moment in time when the user of the mobile device (e.g., the holder of the account) captures an image of a deposit item for deposit. As still another example, in some embodiments, where the mobile banking transaction includes a mobile deposit, the phrase “during the transaction” includes to the moment in time when the mobile device receives a message indicating that an image of the deposit item has been received by a back-end system (e.g., the decisioning apparatus 330).

Regarding block 130, the apparatus is configured to determine that the particular location is associated with a virtual ATM, which may be one or more virtual ATMs. In some embodiments, the virtual ATM is embodied as a hardware module and/or software module that is configured to receive, designate, and/or process one or more mobile banking transactions. Additionally or alternatively, in some embodiments, the virtual ATM is embodied as a set of rules that govern how a mobile banking transaction should be, will be, and/or is processed.

It will be understood that, in some embodiments, the purpose of the virtual ATM is to provide a non-physical analog to a physical ATM (and/or other conventional banking channel, such as, for example, banking center, call center, online banking, etc.). In some embodiments, the virtual ATM enables a financial institution to process a mobile banking transaction in a way that is similar or identical to how the financial institution would have processed the transaction if it had been performed at a physical ATM instead of the mobile device. In some embodiments, the mobile banking transaction is processed in accordance with the one or more rules associated with the virtual ATM, where the one or more rules are similar or identical to one or more rules for processing transactions at a physical ATM. Thus, in some embodiments, the holder of the account would not recognize any difference in the way a funds transfer performed using a mobile device is processed versus a funds transfer performed using a physical ATM.

Regarding block 140, the apparatus is configured to designate the transaction for processing in accordance with one or more rules associated with the virtual ATM. Of course, it will be understood that the apparatus designating the transaction for processing (represented by block 140) is not the same as the apparatus actually processing the transaction (represented by block 150). For example, in some embodiments, the transaction designation refers to the function of determining which rule set will govern how the transaction will and/or should be processed. In other words, in some embodiments, the transaction designation refers to the function of determining which virtual ATM (e.g., which module, which rule set, etc.) will and/or should process the transaction. Additionally or alternatively, in some embodiments, the transaction designation refers to the function of assigning an identifier to the transaction, where the identifier identifies the virtual ATM associated with the transaction and/or particular location. In still other embodiments, the transaction designation refers to the function of “bucketing” and/or otherwise grouping the transaction into a predetermined folder, file, and/or other location related to a particular virtual ATM. In some embodiments, the transaction designation at least partially affects how the transaction is processed. Said differently, in some embodiments, the apparatus having the process flow 100 is configured to process the mobile banking transaction based at least partially on the transaction designation.

Further regarding blocks 110-140, the apparatus having the process flow 100 can be configured to receive the transaction information and make the position determination, virtual ATM determination, and transaction designation as part of a single identification, designation, and/or collection effort. For example, in some embodiments, the apparatus is configured to identify all of the mobile deposit transactions performed at the particular location (and/or within a larger predetermined geographic area that includes the particular location). Thereafter, in such embodiments, the apparatus may be configured to designate those transactions for processing in accordance with one or more rules associated with a virtual ATM, where the virtual ATM covers transaction performed at that particular location (and/or within that larger predetermined geographic area). In other embodiments, the apparatus may be additionally or alternatively configured to collect transaction information associated with those transactions and include that transaction information into a batch job, which is described in more detail later herein. In some embodiments, the apparatus is configured to access an account datastore (e.g., the account datastore 338 shown in FIG. 3, etc.) in order to identify, designate, and/or collect this transaction information.

Regarding block 150, the apparatus is also configured to process the transaction based at least partially on the transaction information and in accordance with one or more rules associated with the virtual ATM. In some embodiments, the apparatus is configured to process the mobile banking transaction based at least partially on the transaction designation. In some embodiments, the apparatus is configured to dynamically process the mobile banking transaction in real-time. Additionally or alternatively, in some embodiments, the apparatus having the process flow 100 can be configured to process the transaction as part of executing a daily batch job. In some embodiments, the apparatus is configured to process the mobile banking transaction by transferring funds and/or credit into and/or out of the account as a result of the transaction. Additionally or alternatively, in some embodiments, the apparatus is configured to process the mobile banking transaction by posting the mobile banking transaction to the account.

As used herein, the phrase “post the transaction to the account” generally refers to the function of storing transaction information associated with the transaction (e.g., transaction description, transaction type, date of transaction, transaction amount, etc.) in a computer-readable medium, where the computer-readable medium includes information associated with the account (e.g., routing number and/or account number, account description, account type, etc.). For example, in some embodiments, the transaction referred to in block 110 posts to the account when a description of the transaction and/or the transaction amount is stored and/or displayed in an electronic and/or physical transaction ledger associated with the account. In some embodiments, this transaction ledger is shown in an electronic banking account (e.g., online banking account, mobile banking account, etc.) associated with the account and/or that is accessible to a holder of the account. However, in other embodiments, this transaction ledger is accessible only to a financial institution that maintains the account and is not shown in the electronic banking account and/or accessible to the account holder.

In some embodiments, the transaction posts to the account when the transaction is “hard-posted” to the account. In some embodiments, this means that the transaction is cleared by a financial institution that maintains the account. As used herein, it will be understood that cleared transactions are not necessarily final (i.e., “finalized”) because there may be some circumstances in which such transactions may be reversed. Additionally or alternatively, a transaction hard-posts to an account when funds are actually moved into or out of the account as a result of the transaction. Similarly, in some embodiments, a transaction hard-posts to an account when credit is actually incremented to or decremented from the account as a result of the transaction. In some embodiments, the transaction additionally or alternatively hard-posts to the account when the transaction is assigned a particular posting date by a financial institution that maintains the account. For example, in some embodiments, the transaction referred to in block 110 posts to the account when the apparatus having the process flow 100 electronically assigns to the transaction the posting date. In other embodiments, the transaction posts to the account when the transaction is “soft-posted” and/or “memo-posted” to the account. In some embodiments, this means that the transaction is posted to a transaction ledger displayed in the electronic banking account.

Regarding block 150, in some embodiments, the apparatus is also configured to generate a digital receipt (and/or a physical receipt), i.e., an acknowledgement of the transaction. The apparatus transmits the receipt to the user (or to a mobile device associated with the user) via one or more communication methods (e.g., email, short message service (SMS), facsimile, postal mail, voice mail, etc.). The generation and transmittal of a receipt to the user regarding the transaction may also help a financial institution comply with one or more federal regulations. In some embodiments, the receipt summarizes the transaction that has been processed and/or the status of the account after the transaction has been processed. In other embodiments, the receipt may additionally or alternatively include information associated with the transaction, and/or the particular location where the transaction was executed, and/or a reference number associated with the virtual ATM that processed the transaction, etc.

In some embodiments, the apparatus having the process flow 100 can be configured to perform any one or more portions of the process flow 100 represented by blocks 110-150 upon or after one or more triggering events, which, in some embodiments, is one or more of the other portions of the process flow 100. As used herein, it will be understood that a “triggering event” refers to an event that automatically triggers the execution, performance, and/or implementation of a triggered action, either immediately, nearly immediately (i.e., within minutes), or sometime after the occurrence of the triggering event. For example, in some embodiments, the apparatus is configured such that the apparatus receiving the transaction information (the triggering event) automatically and immediately triggers the apparatus to determine, based at least partially on the transaction information, that the mobile device is positioned at a particular location during the transaction (the triggered action). In some embodiments, the apparatus is additionally or alternatively configured to determine the particular location is associated with a virtual ATM (triggered action) simultaneous with or sometime after (e.g., minutes after, hours after, etc.) determining that the mobile device is positioned at a particular location during the transaction (triggering event).

In some embodiments, a predetermined time and/or the passage of a predetermined period of time may serve to trigger one or more of the portions represented by blocks 110-150. Also, in some embodiments, the apparatus is configured to automatically perform one or more (or all) of the portions of the process flow 100 represented by blocks 110-150. In other embodiments, one or more (or all) of the portions of the process flow 100 represented by blocks 110-150 require and/or involve at least some human intervention. In addition to the process flow 100, any of the embodiments described and/or contemplated herein can involve one or more triggering events, triggered actions, automatic actions, apparatus actions, and/or human actions. Further, it will be understood that one or more portions of the process flow 100 can occur at any time with respect to the status of the transaction referred to in block 110. For example, in some embodiments, the apparatus is configured to perform one or more portions of the process flow 100 after the transaction is initiated and/or after the transaction is authorized but before the transaction is finalized.

It will also be understood that the apparatus having the process flow 100 can be configured to perform any one or more portions of any embodiment described and/or contemplated herein, including, for example, any one or more portions of the process flow 200 described later herein. In addition, the number, order, and/or content of the portions of the process flow 100 are exemplary and may vary. Indeed, the process flow 100, like all of the other process flows described herein, can include one or more additional and/or alternative process flow portions, and the apparatus configured to perform the process flow 100 can be configured to perform one or more additional and/or alternative functions. For example, in some alternative embodiments, the apparatus having the process flow 100 is configured to process the mobile banking transaction, as represented by block 150, without ever designating the transaction for processing, as represented by block 140. In other words, in such embodiments, the apparatus is configured to omit the transaction designation and is configured to process the transaction after making the virtual ATM determination.

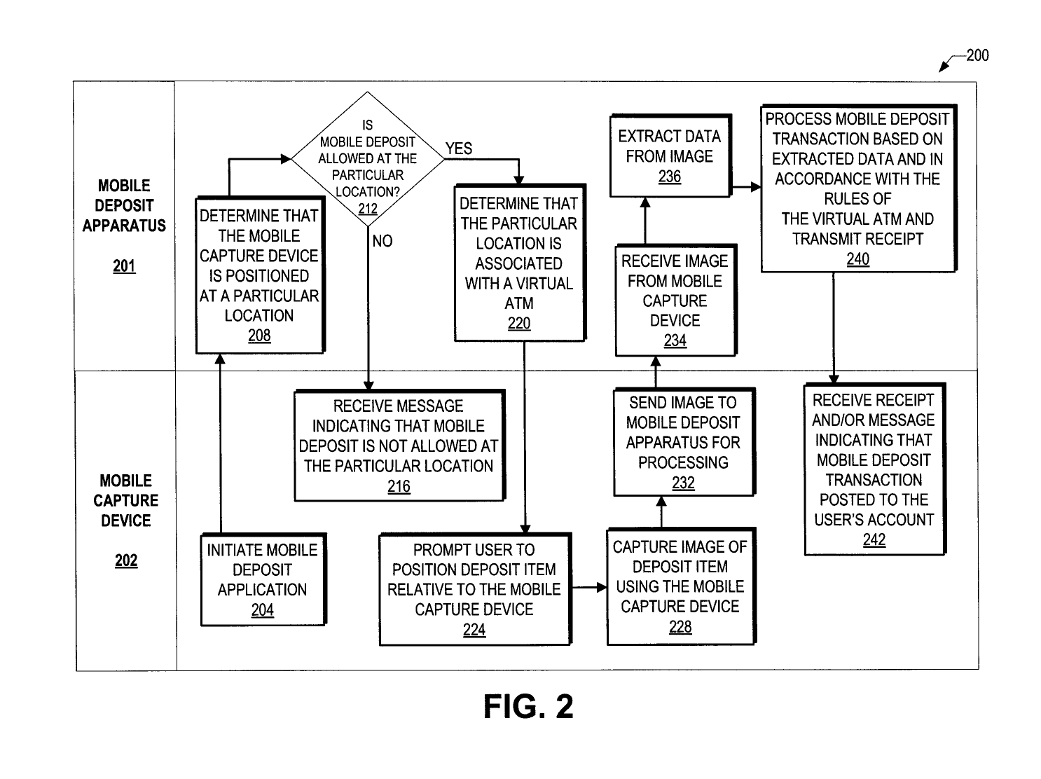

Referring now to FIG. 2, a process flow 200 is provided for processing a mobile deposit transaction, in accordance with an embodiment of the present invention. The term “deposit,” as used herein, generally refers to the process of depositing a deposit item (and/or the funds and/or credit corresponding thereto) into an account associated with the account holder. In some embodiments, the process flow 200 is performed by an apparatus having hardware and/or software configured to perform one or more portions of the process flow 200. In some of these embodiments, the apparatus having the process flow 200 includes a mobile deposit apparatus 201 (e.g., the decisioning apparatus 330 and/or the processing apparatus 340, etc.) and a mobile capture device 202 (e.g., the mobile capture device 320). Additionally, in some embodiments, the apparatus having the process flow 200 is also configured to perform the process flow 100 (and/or vice versa). In such embodiments, the process flow 200 represents a more-specific example of the process flow 100 described in connection with FIG. 1.

As represented by block 204, the mobile capture device 202 is configured to initiate a mobile deposit application. For example, in some embodiments, the mobile capture device is an iPhone®, and the mobile deposit application is an “app” that executes on the iPhone® for initiating, executing, completing, and/or otherwise facilitating a deposit transaction involving the mobile capture device. In some embodiments, the mobile banking application requires the user to identify and/or authenticate himself. For example, in some embodiments, the user must provide a username/password, personal identification number (PIN), smart card, token (e.g., USB token, etc.), biometric information, and/or some other information, device, and/or credential to the mobile capture device prior to that device granting the user access to the application.

Thereafter, the mobile deposit apparatus 201 is configured to determine that the mobile capture device is positioned at a particular location, as represented by block 208. This location may be obtained by the mobile deposit apparatus which communicates, via one or more other systems, with a positioning system device that is located in the mobile capture device. This location may be a location anywhere in the U.S. In other embodiments, this location may be any international location, including a location at sea (e.g., on a cruise ship). In other embodiments, this location may be a location in the air (e.g., on an airplane).

Thereafter, the mobile deposit apparatus 201 is configured to determine whether a mobile deposit is allowed at the particular location, as represented by block 212. In some embodiments, the decision of whether the user is allowed to make a deposit of a deposit item is based on the location associated with the mobile capture device. The phrase “deposit item,” as used herein, generally refers to one or more checks (e.g., personal checks, business checks, cashier's checks, credit card convenience checks, certified checks, pay checks, traveler's checks, etc.), money orders, deposit slips, payment vouchers, and/or the like. In some embodiments, the “deposit item” refers to two or more deposit items and/or to two or more different types of deposit items.

If the mobile deposit apparatus 201 determines that a deposit of the deposit item is not allowed, then the process flow 200 moves to block 216. At block 216, the mobile deposit apparatus 201 sends a message to the mobile capture device 202, where the message indicates to the user that the mobile deposit service is not available at the particular location associated with the mobile capture device. For instance, a user may not be allowed to make a mobile deposit while traveling through a particular part of the state of Idaho. For example, in some embodiments, a mobile deposit is not allowed in that part of Idaho because there are no physical ATMs in that part of Idaho. In another embodiment, a deposit via the mobile deposit service is not allowed in that part of Idaho because of one or more policies associated with the financial institution (or the state or other federal entities) or agreements between the financial institution and the state (and/or the federal entities). In another embodiment, the user may not be allowed to make a deposit while traveling through that part of Idaho because of one or more reasons not related to the location of the mobile capture device. For instance, the user may not be allowed to make a deposit due to a risk factor associated with the user, e.g., a recent behavior exhibited by the user that causes the user to be not trustworthy enough to use the mobile deposit application.

Referring again to block 208, if the mobile deposit apparatus 201 determines that the mobile deposit is allowed at the particular location, then the process flow 200 moves to block 220. In other embodiments, the mobile deposit apparatus 201 determines that a deposit of the deposit item is allowed based on factors other than the location of the mobile capture device. At block 220, the mobile deposit apparatus determines that the particular location is associated with a virtual ATM. In some embodiments, the virtual ATM includes and/or is embodied as one or more rules for processing the mobile deposit.

Thereafter, at block 224, the mobile capture device 202 may prompt the user to position the front surface of the deposit item such that the deposit item is exposed to the mobile capture device. In some embodiments, this means that the user is prompted to position the deposit item on a flat surface, and/or position the deposit item such that the mobile capture device is positioned orthogonally with respect to the deposit item, and/or position the deposit item such that all four corners of the deposit item are captured, and/or position the deposit item such that the front surface of the deposit item is illuminated by adequate lighting, etc. In some embodiments, the user is prompted to position the mobile capture device 202 proximate and/or relative to the deposit item, such that light from the deposit item is physically received by the mobile capture device 202. For example, in some embodiments, the mobile capture device 202 includes a photographic lens and an image sensor, and the image sensor is configured to generate an image of the deposit item based at least partially on light from the deposit item passing through the lens, reaching the image sensor, and being converted into electrical signals by the image sensor. It will be understood that the mobile capture device 202 can be configured to generate one or more still images of the deposit item and/or a series of video images of the deposit item.

Once the user positions the deposit item relative to the mobile capture device 202, the mobile capture device 202 is configured to enable the user to perform an action (such as clicking on, pressing, or otherwise selecting a digital button, a physical button, or the like) so that the mobile capture device 202 captures an image of the front surface of the deposit item, as represented by block 228. In another embodiment, the mobile capture device 202 may automatically capture an image of the front surface of the deposit item once the mobile capture device 202 determines that the front surface of the deposit item is appropriately exposed to the mobile capture device 202. In some embodiments, the mobile capture device 202 “capturing” the image generally means that the mobile capture device 202 stores the image of the deposit item in the memory of the mobile capture device 202. In some embodiments, this memory is non-temporary, non-volatile, and/or long-term persistent memory. Additionally or alternatively, in some embodiments, the image is captured if a user of the mobile capture device 202 can retrieve the image from the memory of the mobile capture device sometime after the deposit item is exposed to the mobile capture device 202. Of course, it will be understood that the mobile capture device 202 may not capture every image that it generates. For example, in some embodiments, the mobile capture device 202 discards and/or erases generated images that are not captured. However, in other embodiments, the mobile capture device 202 does not discard or erase generated images that are not captured, but instead identifies and/or stores them differently. For example, in some embodiments, the mobile capture device 202 stores generated but not captured images in temporary and/or volatile memory, whereas the mobile capture device stores captured images in non-temporary, non-volatile, and/or long-term persistent memory.

In some embodiments, the mobile capture device 202 may repeat the functions represented by blocks 224 and 228 for the back surface of the deposit item. Thereafter, as represented by block 232, the mobile capture device 202 transmits the image (e.g., via a wireless network, via the Internet, etc.) to the mobile deposit apparatus 201. Thereafter, at block 234, the mobile deposit apparatus 201 receives the image and, as represented by block 236, extracts data from the image. For example, the mobile deposit apparatus 201 may extract the routing data, the account data, the MICR data, the transaction amount, the payee name, the payor name, and/or other data printed on and/or associated with the deposit item.

Thereafter, at block 240, the mobile deposit apparatus 201 processes the mobile deposit transaction based at least partially on the extracted data and in accordance with the rules of the virtual ATM. In some embodiments, the processing step includes depositing funds and/or otherwise crediting the account associated with the user, where the amount of the funds and/or credit is equal to the transaction amount of the deposit item. In some embodiments, the account is not instantly credited when making a deposit via the mobile capture device 202. In some embodiments, a processing fee may be deducted from the amount of the deposit item. As explained with respect to FIG. 1, processing a mobile transaction may also comprise posting the transaction to the account. In some embodiments, the mobile deposit apparatus 201 also generates a digital receipt (or physical receipt), i.e., an acknowledgement of the transaction, that can be transmitted to the user (or to the mobile capture device 202) via one or more communication methods (e.g., email, short message service (SMS), facsimile, postal mail, voice mail, etc.). The generation and transmittal of a receipt to the user regarding the transaction also helps a financial institution comply with one or more federal regulations. In some embodiments, the receipt indicates the latest balance associated with the account after the account has been credited with the deposited funds. In other embodiments, the receipt may additionally or alternatively include information associated with the mobile deposit, and/or the particular location where the mobile deposit was executed, and/or a reference number associated with the virtual ATM that processed the mobile deposit, etc.

Thereafter, at block 242, after processing the transaction, the mobile capture device 202 receives a message from the mobile deposit apparatus 201, where the message indicates that the mobile deposit transaction is posted to the account associated with the user. In some embodiments, at block 242, the mobile deposit apparatus 201 receives a digital or physical receipt associated with the transaction.

Referring now to FIG. 3, a system 300 is provided for processing mobile banking transactions, in accordance with an embodiment of the present invention. It will be understood that the system 300 can be configured to process any type of mobile banking transaction, including, for example, funds transfers, mobile deposits, new account openings, bill pay, and/or the like. However, as shown in this exemplary embodiment, the system 300 is illustrated as performing a mobile deposit transaction.

The exemplary system 300 includes a network 310, a mobile capture device 320, a decisioning apparatus 330, and a processing apparatus 340. Also shown are a mobile capture device user 305 and an image 307. The image 307 shows the deposit item, which in the presented embodiment is a physical and/or paper check 301. It will be understood that the check 301 includes the deposit amount 311 of $25, and that the check 301 also includes deposit item information that is not shown (e.g., information associated with a payee identity, an account number, a MICR line, etc.). Also, it will be understood that the mobile capture device user 305 has access to the mobile capture device 320 and to the check 301.

In addition, it will be understood that the user 305 can view, receive, generate, create, acquire, and/or capture the image 307 by using the mobile capture device 320. In some embodiments, the mobile capture device 320 views, receives, generates, and/or captures the image 307 automatically (i.e., without the user's 305 intervention). In addition, in some embodiments, the mobile capture device 320 is exposed to and/or located proximately to the check 301 when the image 307 is viewed, received, generated, and/or captured by the mobile capture device 320. Also, in accordance with some embodiments, the mobile capture device 320 is located remotely from the decisioning apparatus 330.

In addition, it will be understood that, in this example embodiment where the mobile banking transaction is a mobile deposit transaction, the user 305 intends to deposit the sum of the deposit amount 311 (i.e., $25) into the checking account 309. Also, the checking account 309 is held by the user 305 and is maintained by a bank or financial institution (not shown) for the benefit of that user 305, who is a customer of that bank or financial institution. Still further, it will be understood that, in this example embodiment, the mobile capture device 320 is maintained by the mobile capture device user 305, and that the decisioning apparatus 330 is maintained by the same bank that maintains the checking account 309. In another embodiment, the checking account may be any other type of banking account associated with the financial institution.

As shown in FIG. 3, the mobile capture device 320 and the decisioning apparatus 330 are each operatively and selectively connected to the network 310, which may include one or more separate networks. In addition, the network 310 may include one or more interbank networks, telephone networks, telecommunication networks, local area networks (LANs), wide area networks (WANs), and/or global area networks (GANs) (e.g., the Internet, etc.). It will also be understood that the network 310 may be secure and/or unsecure and may also include wireless and/or wireline technology.

The mobile capture device 320 can include any mobile capture device described and/or contemplated herein. In addition, the mobile capture device 320 can initiate, execute, complete, and/or otherwise facilitate any one or more portions of any embodiment described and/or contemplated herein. In some embodiments, the mobile capture device 320 includes one or more mobile phones, gaming devices, digital cameras, handheld scanners, and/or the like. As illustrated in FIG. 3, the mobile capture device 320 includes a communication interface 322, a processor 324, a memory 326 having a mobile capture application 327 stored therein, an image capture device 328, a user interface 329, a positioning system device 331, etc. In such embodiments, the processor 324 is operatively and selectively connected to the communication interface 322, the user interface 329, the image capture device 328, the memory 326, and the positioning system device 331.

Each communication interface described herein, including the communication interface 322, generally includes hardware, and, in some instances, software, that enables a portion of the system 300, such as the mobile capture device 320, to send, receive, and/or otherwise communicate information to and/or from the communication interface of one or more other portions of the system 300. For example, the communication interface 322 of the mobile capture device 320 may include a modem, network interface controller (NIC), network adapter, network interface card, and/or some other electronic communication device that operatively connects the mobile capture device 320 to another portion of the system 300, such as, for example, the decisioning apparatus 330.

Each processor described herein, including the processor 324, generally includes circuitry for implementing the audio, visual, and/or logic functions of that portion of the system 300. For example, the processor may include a digital signal processor device, a microprocessor device, and/or various analog-to-digital converters, digital-to-analog converters, and/or other support circuits. Control and signal processing functions of the apparatus in which the processor resides may be allocated between these one or more devices according to their respective capabilities. The processor may also include functionality to operate one or more software programs based at least partially on computer-executable program code portions thereof, which may be stored, for example, in a memory device, such as in the mobile capture application 327 of the memory 326 of the mobile capture device 320.

Each memory device described herein, including the memory 326 for storing the mobile capture application 327 and/or other information, may include any computer-readable medium. For example, the memory may include volatile memory, such as volatile random access memory (RAM) having a cache area for the temporary storage of data. Memory may also include non-volatile memory, which may be embedded and/or may be removable. The non-volatile memory may additionally or alternatively include an EEPROM, flash memory, and/or the like. The memory may store any one or more of portions of information used by the apparatus in which it resides to implement the functions of that apparatus. The memory may be non-transitory or transitory.

As shown in FIG. 3, the memory 326 includes the mobile capture application 327. The mobile capture application 327 may instruct and/or cause the processor 324 (and/or one or more other portions of the mobile capture device 320) to perform any one or more of the functions described herein as being performed by “a mobile capture device,” by the mobile capture device 320, and/or by the mobile capture application 327. Additionally or alternatively, the mobile capture application 327 can be executable to initiate, execute, complete, and/or otherwise facilitate any one or more portions of any embodiment described and/or contemplated herein, such as, for example, any one or more portions of the process flows 100 or 200 described herein.

For example, in some embodiments where the mobile banking transaction is a mobile deposit transaction, the mobile capture application 327 is executable to receive and/or generate an image (e.g., the image 307, etc.) that shows a deposit item (e.g., the check 301, etc.). In some embodiments, the mobile capture application 327 is executable to determine, automatically or otherwise, whether an image (e.g., the image 307, etc.) is satisfactory (i.e., passes a minimum threshold of clarity) for reading deposit item information from the image (e.g., the deposit amount 311 of $25, etc.). In still other embodiments, the mobile capture application 327 is executable to perform, automatically or otherwise, any one or more of the actions represented by blocks of process flow 100 or 200. As another example, in some embodiments, the mobile capture application 327 is executable to automatically capture an image of a deposit item using the image capture device 328, or prompt a user to initiate a process to capture an image of a deposit item using the image capture device. As still another example, in some embodiments, the mobile capture application 327 is additionally or alternatively executable to credit an account (e.g., the account 309, etc.) based at least partially on the deposit item information associated with the deposit item.

In some embodiments, the mobile capture application 327 is additionally or alternatively executable to perform one or more functions other than those previously described herein. For example, in some embodiments, the mobile capture application 327 is executable to require the user 305 to identify and/or authenticate himself/herself to the mobile capture application 327 before the mobile capture application 327 will initiate, execute, complete, and/or otherwise facilitate any of the functions described and/or contemplated herein. For example, in some embodiments, the mobile capture application 327 is executable to identify and/or authenticate the user 305 based at least partially on an username/password, personal identification number (PIN), smart card, token (e.g., USB token, etc.), biometric information, and/or some other information, device, and/or credential that the user 305 provides to the mobile capture application 327. Additionally or alternatively, in some embodiments, the mobile capture application 327 is executable to identify and/or authenticate the user 305 by using one-, two-, or multi-factor identification and/or authentication. For example, in some embodiments, the mobile capture application 327 requires two-factor authentication, such that the mobile capture device user 305 must provide the correct smart card and enter the correct PIN in order to authenticate the user 305 to the mobile capture application 327.

In some embodiments, the mobile capture application 327 may be a mobile banking application that allows a user to execute funds transfers, open additional banking accounts, etc.

It will also be understood that, in some embodiments, the mobile capture application 327 is executable to enable the mobile capture device user 305 and/or the mobile capture device 320 to communicate with one or more other portions of the system 300, and/or vice versa. In some embodiments, the mobile capture application 327 is executable to access an electronic banking service (e.g., online banking, mobile banking, SMS banking, etc.). Further it will be understood that, in some embodiments, the mobile capture application 327 is created, provided, controlled, and/or maintained by the bank that maintains the decisioning apparatus 330 and/or by an individual or business (not shown). For example, in some embodiments, the mobile capture device 320 is embodied as an iPhone®, and the mobile capture application 327 is embodied as an “app” that was created by a bank and/or by a software maker for execution on the iPhone®. Also, it will be understood that, in some embodiments, the mobile capture application 327 includes one or more computer-executable program code portions for instructing the processor 324 to perform one or more of the functions of the mobile capture application 327 and/or of the mobile capture device 320 described and/or contemplated herein. In some embodiments, the mobile capture application 327 may include and/or use one or more network and/or system communication protocols.

Also shown in FIG. 3 is the image capture device 328, which may include one or more cameras (e.g., digital or otherwise, etc.), charge coupled devices (CCD), complementary metal-oxide-semiconductor (CMOS) sensors, image sensors, and/or the like, including any one or more of the image capture devices described and/or contemplated herein. The image capture device 328 may include one or more different types of image capture devices. In some embodiments, the image capture device 328 is configured to receive, detect, recognize, and/or capture optical light, ultraviolet light, and/or infrared light. In some embodiments, the image capture device 328 can be configured to view, receive, acquire, generate, create, and/or capture one or more still images and/or videos. In some embodiments, the image capture device 328 is configured to communicate one or more generated and/or captured images to the processor 324. Additionally or alternatively, in some embodiments, the image capture device 328 includes one or more features, including, but not limited to, a zoom, focus, flash, lens, shutter, viewfinder, and/or the like. In some embodiments, the image capture device 328 has a resolving power, which, for example, defines the detail and/or resolution with which an image can be generated and/or captured by the image capture device 328.

In some embodiments, the resolving power associated with the image capture device 328 is measured in the number of pixel sensors (sometimes referred to merely as “pixels”) used by the image capture device 328 in order to capture the image. In some embodiments, the image capture device 328 is housed in the mobile capture device 320. However, in other embodiments, the image capture device 328 is operatively connected to the mobile capture device 320 but is not housed in the mobile capture device 320; instead, in such embodiments, the image capture device 328 is located adjacent, near, within arm's reach, and/or otherwise proximate to the mobile capture device 320 (e.g., a peripheral digital camera plugged into a mobile phone, etc.).

It will also be understood that the mobile capture device 320 also includes the user interface 329. It will be understood that the user interface 329 (and any other user interface described and/or contemplated herein) can include and/or be embodied as one or more user interfaces. In some embodiments, the user interface 329 includes one or more user output devices for presenting (e.g., communicating, rendering, displaying, outputting, etc.) information to the user 305, such as, for example, one or more displays, speakers, and/or the like. In some embodiments, the user interface 329 additionally or alternatively includes one or more user output devices for presenting information to the mobile capture device user 305. In some embodiments, the user interface 329 additionally or alternatively includes one or more user input devices, such as, for example, one or more buttons, keys, dials, levers, directional pads, joysticks, keyboards, mouses, accelerometers, controllers, microphones, touchpads, touchscreens, haptic interfaces, scanners, biometric readers, motion detectors, cameras, and/or the like for receiving information from one or more items (e.g., the check 301, etc.) and/or the mobile capture device user 305. In some embodiments, the user interface 329 is housed in the mobile capture device 320. However, in other embodiments, the user interface 329 is operatively connected to the mobile capture device 320 but is not housed in the mobile capture device 320; instead, in such embodiments, the user interface 329 is located adjacent, near, within arm's reach, and/or otherwise proximate to the mobile capture device 320 (e.g., a peripheral touchscreen display plugged into a digital camera, etc.).

In some embodiments, the mobile capture device 320 comprises a positioning system device 331 that is configured to be used by the decisioning apparatus 330 to determine a location associated with the mobile capture device 320. For example, the positioning system device 331 may include a global positioning system (GPS) transceiver that communicates with a GPS satellite. The decisioning apparatus 330 may be able to receive GPS coordinates associated with the mobile capture device by communicating with the GPS satellite.

In some embodiments, the positioning system device 331 is at least partially made up of an antenna, a transmitter, and a receiver. In some embodiments, triangulation of cellular signals may be used to identify the approximate location of the mobile capture device 320. For instance, the decisioning apparatus 330 may be able to identify a cell site, i.e., cell tower that is located close to or closest to the mobile capture device 320. As a further instance, the decisioning apparatus 330 may be able to identify a cell site that is communicating with the mobile capture device 320, even though the cell site is not the closest cell site to the mobile capture device 320.

In other embodiments, the positioning system device 331 includes a proximity sensor or transmitter, such as an RFID tag, that can sense or be sensed by devices known to be located proximate a merchant or other location to determine that the mobile capture device 320 is located proximate these devices. The decisioning apparatus 330 may then communicate with these devices to determine the location of the mobile capture device 320.

In some embodiments where the mobile capture device 320 is on a network, the decisioning apparatus 330 can identify or receive a network address associated with the mobile capture device 320. In some embodiments, the decisioning apparatus 330 may receive the network address by either ‘pinging’ the mobile capture device or some other system on the network that retains information about one or more devices on the network. In some embodiments, the network address is an Internet Protocol (IP) address.

FIG. 3 also illustrates the decisioning apparatus 330. In some embodiments, the decisioning apparatus 330 may include one or more servers, mainframes, engines, network devices, front end systems, back end systems, and/or the like. In some embodiments, such as the one illustrated in FIG. 3, the decisioning apparatus 330 includes a communication interface 332, a processor 334, and a memory 336, which includes a decisioning application 337 and an account datastore 338 stored therein. As shown, the communication interface 332 is operatively connected to the processor 334, which is operatively connected to the memory 336.

The decisioning application 337 may instruct and/or cause the processor 334 (and/or one or more other portions of the decisioning apparatus 330) to perform any one or more of the functions described herein as being performed by “a decisioning apparatus,” by the decisioning apparatus 330, and/or by the decisioning application 337. Additionally or alternatively, the decisioning application 337 can be executable to initiate, execute, complete, and/or otherwise facilitate any one or more portions of any embodiment described and/or contemplated herein, such as, for example, any one or more portions of the process flow 100 or 200 described herein.

For example, in some embodiments where the mobile banking transaction executed by the user is a mobile deposit transaction, the decisioning application 337 is executable to receive an image that shows a deposit item (e.g., the image 307 that shows the check 301, etc.). As another example, in some embodiments, the decisioning application 337 is executable to read deposit item information (e.g., the deposit amount 311, etc.) from a captured image. As another example, in some embodiments, the decisioning application 337 is additionally or alternatively executable to credit an account (e.g., the checking account 309, etc.) based at least partially on the deposit item information associated with the deposit item. For example, in some embodiments, the decisioning application 337 is executable to transfer funds from a payor account identified in the deposit item information, in an amount identified in the deposit item information, and to a payee account identified in the deposit item information. In some embodiments, the decisioning application 337 can be configured to perform one or more of the same functions previously described herein as being performed by the mobile capture application 327 (and/or vice versa).

It will also be understood that, in some embodiments, the decisioning application 337 is configured to enable the decisioning apparatus 330 to communicate with one or more other portions of the system 300, such as, for example, the account datastore 338 and/or the mobile capture device 320, and/or vice versa. It will further be understood that, in some embodiments, the decisioning application 337 is configured to initiate, execute, complete, and/or otherwise facilitate one or more financial transactions and/or to maintain one or more financial accounts (e.g., the checking account 309, etc.) stored in the account datastore 338. In some embodiments, the decisioning application 337 includes one or more computer-executable program code portions for instructing the processor 334 to perform one or more of the functions of the decisioning application 337 and/or decisioning apparatus 330 described and/or contemplated herein. In some embodiments, the decisioning application 337 may include and/or use one or more network and/or system communication protocols.

In addition to the decisioning application 337, the memory 336 also includes the account datastore 338. It will be understood that the account datastore 338 can be configured to store any type and/or amount of information. For example, in some embodiments, the account datastore 338 includes information associated with one or more transactions, accounts, users or account holders, and/or the like. In some embodiments, the account datastore 338 may also store any information related to processing images captured by mobile capture devices. In some embodiments, the account datastore 338 additionally or alternatively stores information associated with electronic banking services.

Also, the account datastore 338 may include any one or more storage devices, including, but not limited to, datastores, data repositories, databases, and/or any of the other storage devices typically associated with a computer system. It will also be understood that the account datastore 338 may store information in any known way, such as, for example, by using one or more computer codes and/or languages, alphanumeric character strings, data sets, figures, tables, charts, links, documents, and/or the like. Further, in some embodiments, the account datastore 338 may include information associated with one or more applications, such as, for example, the decisioning application 337. It will also be understood that, in some embodiments, the account datastore 338 provides a real-time or substantially real-time representation of the information stored therein, so that, for example, when the processor 334 accesses the account datastore 338, the information stored therein is current or nearly current. The account datastore 338 can also dynamically store information, such that the information stored therein (e.g., account balances, transaction information, rules for depositing checks, etc.) can be quickly and/or immediately added, deleted, changed, revised, updated, and/or the like.

Additionally, in some embodiments, the decisioning apparatus comprises a virtual ATM 339. The virtual ATM has been described previously with respect to general mobile banking transactions in FIG. 1. In one example, a mobile banking transaction that can be handled by the virtual ATM is a mobile deposit transaction. In this example, from the user's perspective, the virtual ATM is the module that receives and/or processes the user's deposit of a deposit item via a mobile deposit application. From the financial institution's perspective, the decisioning apparatus processes a deposit of a deposit item in accordance with one or more rules associated with a virtual ATM. Therefore, in some embodiments, the virtual ATM comprises one or more rules associated with depositing a deposit item. For instance, a virtual ATM associated with the state of Wisconsin comprises one or more rules associated with depositing a deposit item in Wisconsin. For instance, a rule might be a daily cutoff rule, where if the deposit item is deposited after the daily cutoff time, the deposit item is not processed until the following day. The same rules are applied if a user physically deposits a deposit item at a physical ATM in Wisconsin. In some embodiments, the processing associated with the virtual ATM is identical to the processing associated with the physical ATM. However, in other embodiments, there may be differences in the processing associated with the virtual ATM when compared to the processing associated with the physical ATM. For instance, an account is instantly credited when a deposit of a deposit item is made to the account via a physical ATM. In some embodiments, an account is not instantly credited when a deposit of a deposit item is made to the account via a virtual ATM. In addition to the virtual ATM associated with the state of Wisconsin, another virtual ATM could be associated with another state, a territory, a foreign country, a body of water, a set of carriers (e.g., ships, airplanes, etc), or a set of contiguous or discontiguous geographical locations, etc.

The virtual ATM is designed to produce ‘ATM-like’ capability. This means that the back-end processing (i.e., the decisioning apparatus's processing) of a deposit item deposited via a mobile deposit application to the virtual ATM associated with a state is similar to the back-end processing associated with depositing a physical deposit item at a physical ATM in that state. From the perspective of a user, there will be minimal to no differences in the manner in which the transaction is processed between a deposit at a physical ATM versus a mobile deposit via a virtual ATM.

A virtual ATM network may comprise one or more virtual ATMs. From the perspective of the financial institution that maintains the virtual ATM network and logic, the virtual ATM network allows users to make deposits via a mobile deposit application in accordance with agreements and relationships (e.g., charter relationships) that the financial institution has with federal agencies and/or the state through which the user is traveling. The virtual ATM network is also designed such that it is easy to manage from an interstate banking perspective for a financial institution that allows transactions to be executed in several states and territories across the country. In the case where the financial institution needs to change a rule associated with the processing of a mobile deposit made in a particular location, the financial institution would only need to tweak the logic for the virtual ATM associated with that particular location. This would automatically affect all the transactions that are assigned to that particular virtual ATM.

One goal of the virtual ATM system is to assign a location to a transaction (or map a transaction to a location), so that from an accounting perspective, the transaction is being performed at a physical location. Therefore, any debit or credit associated with a user's account can be processed in accordance with rules, including accounting rules, associated with the location of the transaction. Essentially, the invention allows a location to be converted into an ATM because a mobile capture device at any location can perform one or more functions associated with an ATM that may have been physically present at the location.

In some embodiments, all the virtual ATMs reside in one or more virtual ATM repositories. Therefore, each virtual ATM may have an address associated with the repository that it resides in. Therefore, a virtual ATM does not have a physical address—it only has a network address. The virtual ATM can be perceived as a non-physical address oriented ATM. Therefore, in some embodiments, the network address of a virtual ATM may be the network address of the repository in which the virtual ATM resides, and in another embodiment, that network address may be further specified by adding the particular network address of where the virtual ATM resides within the repository.

The rules associated with each virtual ATM may be based on the logic associated with existing physical ATMs. Moreover, the structure of the virtual ATM network may be based on the structure of the financial institution's physical ATM network. Therefore, the virtual ATM logic and network may be built by piggybacking on the existing physical ATM framework, including structure, logic, etc.

In some embodiments, all the virtual ATMs reside in the decisioning apparatus. Since each virtual ATM is a rule set for processing a transaction, the decisioning apparatus may quickly access the most appropriate virtual ATM (i.e., a rule set) based on the location of the mobile capture device (i.e., the location of the mobile capture device from where a deposit of a deposit item is executed). In such an embodiment, the network address of a virtual ATM may be the network address of the decisioning apparatus in which the virtual ATM resides, and in another embodiment, that network address may be further specified by adding the particular network address of where the virtual ATM resides within the decisioning apparatus.

In some embodiments, assume that the financial institution now wishes to allow users in a particular location (e.g., a state, a territory, a foreign country, a body of water, a set of carriers, etc.) to use the mobile deposit application, where users in that particular location were not previously allowed to use the mobile deposit application. Users may not have been allowed to use the mobile deposit application until now because of one or more policies associated with the financial institution, policies associated with state/federal agencies, etc. Here, the financial institution needs to add a new virtual ATM to either the decisioning apparatus or to the virtual ATM repository. The invention allows the financial institution to easily add a new virtual ATM. The financial institution or an agent associated with the financial institution may create a new set of rules, where the new set of rules is designed to process transactions (e.g., deposit of deposit items) executed in the newly added location. These new set of rules form a new virtual ATM, where the new virtual ATM is stored in the decisioning apparatus or in a virtual ATM repository that is accessible by the decisioning apparatus. Therefore, a new network address is created for this new virtual ATM so that the new virtual ATM is accessible by the decisioning apparatus or any other system on the network. Therefore, the back-end processing associated with depositing a deposit item via a mobile deposit application to the virtual ATM when traveling through the newly added location is similar to the back-end processing associated with depositing a physical deposit item at a physical ATM in the newly added location.

In some embodiments, a virtual ATM is a server in itself (similar to the decisioning apparatus 330 shown in FIG. 3), where the virtual ATM comprises a communication interface, a processor, and a memory. The memory comprises one or more rules associated with the virtual ATM. In such an embodiment, a deposit of a deposit item that is received by the decisioning apparatus is forwarded to an appropriate virtual ATM, based at least partially on the location associated with the mobile capture device. In such an embodiment, the virtual ATM receives the deposit item and the processor associated with the virtual ATM processes the deposit item in accordance with the one or more rules associated with the virtual ATM. In some embodiments, the deposit item may be stored in either a temporary or permanent storage space associated with the virtual ATM.

FIG. 3 also illustrates the processing apparatus 340. The processing apparatus may perform processes associated with block 150 of FIG. 1, including processing of mobile banking transactions (e.g., mobile deposit transactions). In some embodiments, the processing apparatus dynamically processes a mobile banking transaction in real-time. In other embodiments, the processing apparatus processes a batch of mobile banking transactions together, wherein each of the mobile banking transactions was executed during a predetermined period (e.g., the previous twenty-four hours). Additionally, the processing apparatus may perform one or more processes performed by the decisioning apparatus 330.

Of course, it will be understood that the embodiment of the system 300 illustrated in FIG. 3 is exemplary and that other embodiments may vary. For example, in some embodiments, some or all of the portions of the system 300 are combined into a single portion. Specifically, in some embodiments, the mobile capture device 320 and the decisioning apparatus 330 are combined into a single mobile capture and deposit device that is configured to perform all of the same functions of those separate portions as described and/or contemplated herein. Likewise, in some embodiments, some or all of the portions of the system 300 are separated into two or more distinct portions. In addition, the various portions of the system 300 may be maintained by the same or separate parties. For example, in some embodiments, a bank may maintain the decisioning apparatus 330, whereas the mobile capture device user 305 may maintain the mobile capture device 320. However, in other embodiments, a bank may maintain the decisioning apparatus 330 and the mobile capture device 320.

It will also be understood that the system 300 (and/or one or more portions of the system 300) may include and/or implement any embodiment of the present invention described and/or contemplated herein. For example, in some embodiments, the system 300 (and/or one or more portions of the system 300) is configured to implement any one or more of the embodiments of the process flow 100 and/or 200 described and/or contemplated herein in connection with FIGS. 1 and 2.

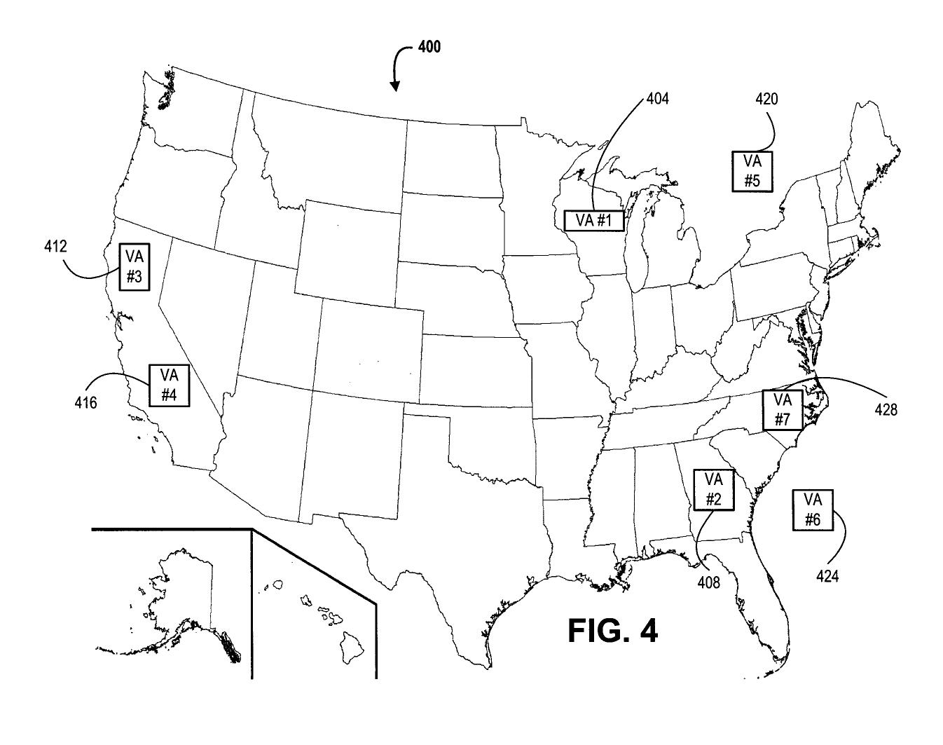

Referring now to FIG. 4, an exemplary map 400 of the United States is provided that illustrates how virtual ATMs may be associated with various locations on the map 400, in accordance with an embodiment of the present invention. In this embodiment, each of the distinct virtual ATMs 404, 408, 412, 416, 420, 424, 428 may be stored in a single system, e.g., a decisioning apparatus or a virtual ATM repository. In the embodiment shown in FIG. 4, block 404 represents a virtual ATM (VA #1) associated with the state of Wisconsin. In some embodiments, a financial institution's policies may allow a user to engage in mobile banking transactions in Wisconsin (e.g., make deposits via the mobile capture application in Wisconsin). Therefore, when a resident of North Carolina travels to Wisconsin and uses the mobile capture application to execute a mobile banking transaction while in Wisconsin, an apparatus (e.g., the decisioning apparatus 330) or a user designates or assigns virtual ATM 404 for this transaction (not virtual ATM 428 (VA #7)). Thus, the mobile banking transaction is processed in accordance with one or more rules associated with virtual ATM 404. Also, in some of these embodiments, the financial institution may treat the act of executing a mobile banking transaction while traveling through Wisconsin similarly or equivalently to executing a banking transaction at a physical ATM in Wisconsin.

Additionally, it will be understood that, in some embodiments, the virtual ATM 404 is not located in Wisconsin. Instead, in some embodiments, one or more (or all) of the virtual ATMs displayed on the map 400 are situated in a decisioning apparatus or a virtual ATM repository that may be located anywhere in the U.S. or outside the U.S. In other embodiments, the various virtual ATMs may be situated in different geographical locations. In some of these embodiments, the virtual ATMs may be situated in the predetermined geographic areas to which they correspond. In some embodiments, an address for a virtual ATM may be defined by the network address associated with the virtual ATM, and in other embodiments, the address may be additionally or alternatively defined by a geographical address associated with the virtual ATM. For instance, virtual ATMs 408, 424 and 428 may be situated in a single processing center on the east coast of the United States, while virtual ATMs 412 and 416 may be situated in a single processing center on the west coast of the United States.

Similar to the assignment of virtual ATM 404 to transactions associated with the state of Wisconsin, an apparatus or a user assigns virtual ATM 408 (VA #2) to transactions associated with the state of Georgia. Therefore, a user (i.e., a customer of the financial institution) who travels through Georgia may execute a mobile banking transaction while in Georgia. The mobile banking transaction is processed in accordance with one or more rules associated with virtual ATM 408. In some embodiments, a financial institution may not have a charter relationship with the state of Georgia, but the financial institution may still allow physical banking transactions (e.g., physical deposit of deposit items) in Georgia. In such embodiments, the processing of the physical banking transaction may be different from an embodiment where the financial institution does have a charter relationship with that state. Therefore, in such an embodiment, a virtual ATM associated with the state of Georgia will have logic to reflect this difference in processing, so that a mobile banking transaction executed via a mobile capture application is processed in the same manner as a banking transaction at a physical ATM in Georgia.

Similar to the assignment of virtual ATM 404 to transactions associated with the state of Wisconsin, an apparatus or a user may assign virtual ATMs 412 (VA #3) and 416 (VA #4) to transactions associated with the state of California (assuming that a financial institution's policies allow a user to use a mobile capture application in California and/or execute mobile banking transactions via the mobile capture application in California). In this embodiment, an apparatus or a user may assign a virtual ATM 412 to transactions associated with a first portion of California, and the apparatus or the user may assign virtual ATM 416 to transactions associated with a second portion of California. The first and second portions may either be contiguous or discontiguous portions of California. In some embodiments, the first and second portions may have overlapping sections of the state. If the user is situated in such an overlapping section when executing a mobile banking transaction, the decisioning apparatus may automatically choose the virtual ATM that the most favorable rules associated with the user's transaction (e.g., later daily cut-off time)

Assume that California has two time zones even though it does not. In some embodiments, the first portion of the state is associated with a first time zone, and the second portion of the state is associated with a second time zone. In such an embodiment, an apparatus or a user may assign virtual ATM 412 to transactions associated with the first portion of the state and virtual ATM 416 to transactions associated with the second portion of the state, or vice versa.

In another embodiment, a financial institution may have multiple processing centers associated with a single state. Assume that in some embodiments California has two processing centers. In such an embodiment, the first portion of the state is associated with a first processing center, and the second portion of the state is associated with a second processing center. In such an embodiment, an apparatus or a user may assign virtual ATM 412 to transactions associated with the first portion of the state and virtual ATM 416 to transactions associated with the second portion of the state, or vice versa.

Therefore, a user (i.e., a customer of the financial institution) who travels through locations associated with the first portion of California may execute a mobile banking transaction via the mobile capture application, where the mobile banking transaction is governed by or processed in accordance with one or more rules associated with virtual ATM 412. A user (i.e., a customer of the financial institution) who travels through locations associated with the second portion of California may execute a mobile banking transaction via the mobile capture application, where the mobile banking transaction is governed by or processed in accordance with one or more rules associated with virtual ATM 416.

Similar to the assignment of virtual ATM 404 to transactions associated with the state of Wisconsin, an apparatus or a user assigns virtual ATM 420 (VA #5) to transactions associated with the country of Canada (assuming that a financial institution's policies allow a user to use a mobile capture application in Canada and/or execute mobile banking transactions via the mobile capture application in Canada). Therefore, a user (i.e., a customer of the financial institution) who travels through Canada may execute a mobile banking transaction while in Canada. The mobile banking transaction is processed in accordance with one or more rules associated with virtual ATM 420. In some embodiments, an apparatus or a user may assign a separate virtual ATM to transactions associated with every country where the user is allowed to execute a mobile banking transaction via a mobile capture application.

Similar to the assignment of virtual ATM 404 to transactions associated with the state of Wisconsin, an apparatus or a user may assign virtual ATM 424 (VA #6) to transactions associated with ships, such as cruise ships (assuming that a financial institution's policies allow a user to use a mobile capture application in ships and/or execute mobile banking transactions via the mobile capture application in ships). Therefore, a user (i.e., a customer of the financial institution) who travels on a ship may execute a mobile banking transaction via a mobile capture application while traveling on a ship. The mobile banking transaction is processed in accordance with one or more rules associated with virtual ATM 424. In some embodiments, an apparatus or a user may assign a separate virtual ATM to transactions associated with every ship where the user is allowed to execute a mobile banking transaction via a mobile capture application. In some embodiments, an apparatus or a user may assign a single virtual ATM to transactions associated with one or more ships that are associated with a single shipping carrier. In another embodiment, an apparatus or a user may assign a single virtual ATM to transactions associated with one or more ships that travel in a particular body of water. Therefore, for instance, an apparatus or a user may assign virtual ATM 424 to transactions associated with one or more ships that travel in the Atlantic Ocean.

In another embodiment, an apparatus or a user may assign virtual ATM 424 to transactions associated with airplanes or any other flying bodies such as helicopters, balloons, gliders, etc. (assuming that a financial institution's policies allow a user to use a mobile capture application in airplanes and/or execute mobile banking transactions via the mobile capture application in airplanes). Therefore, a user (i.e., a customer of the financial institution) who travels on an airplane may execute a mobile banking transaction via a mobile capture application while traveling on an airplane. The mobile banking transaction is processed in accordance with one or more rules associated with virtual ATM 424. In some embodiments, an apparatus or a user may assign a single virtual ATM to transactions associated with one or more airplanes associated with a single carrier. In another embodiment, when a user execute a mobile banking transaction via a mobile capture application while flying on an airplane, an apparatus or a user may assign to the transaction the virtual ATM that is associated with the ground below the airspace through which the airplane is flying. Therefore, for instance, assume an airplane is flying over Wisconsin. When the airplane is flying over Wisconsin and the user executes a mobile banking transaction via a mobile capture application, an apparatus or a user assigns virtual ATM 404 to the transaction. In some embodiments, if there is no virtual ATM assigned to transactions associated with Wisconsin, then when the airplane is flying over Wisconsin, the user will not be able to execute a mobile banking transaction via a mobile capture application.

Now assume that the user is traveling through Florida. Assume that a financial institution's policies do not allow a user to execute mobile banking transactions in Florida. Since a financial institution's policies do not allow a user to execute mobile banking transactions in Florida, there is no virtual ATM assigned to transactions associated with the state of Florida (see FIG. 4). This means that when a user is traveling through Florida, the user will not be able to execute mobile banking transactions via a mobile capture application. For instance, if a user traveling through Florida executes a mobile capture application, the decisioning apparatus may determine that the user is in Florida, and initiate a message on the user interface of the mobile capture device indicating that mobile banking transactions are not permitted in Florida. In some embodiments, the decisioning apparatus may indicate to the user the minimum distance that the user would need to travel (and the accompanying directions) in order to reach a location where the user will be able to execute mobile banking transactions via a mobile capture application.

In some embodiments, the location associated with a user is not determined until the user transmits transaction information associated with the mobile banking transaction to the decisioning apparatus, i.e., the location of the user is not determined until block 236 of FIG. 2. In such an embodiment, the decisioning apparatus may determine that the transaction was executed (i.e., the transaction information was sent) from a location in Florida. At that point, the decisioning apparatus will determine that the user is not allowed to execute mobile banking transactions from Florida, and will initiate the communication of a message to the user. The user may receive a message by one or more communication mechanisms (e.g., voice, email, short message service (SMS), etc.) indicating that the user's execution of a mobile banking transaction cannot be processed because mobile banking transactions are not allowed at the location where the user executed the transaction. Alternatively, the user may receive a substantially real-time message on the user interface of the mobile capture device, where the message indicates that the mobile banking transaction has been rejected by the decisioning apparatus because mobile banking transactions are not allowed in Florida.

Thus, present embodiments of the present invention relate to systems, methods and computer program products for processing transaction information associated with a mobile banking transaction. In some embodiments, the mobile banking transaction is a deposit of a deposit item via a mobile deposit application.

Although many embodiments of the present invention have been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” For example, various embodiments may take the form of web-implemented computer software. Furthermore, embodiments of the present invention may take the form of a computer program product on a computer-readable medium having computer-executable program code embodied in the medium.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein above with reference to flowchart illustrations and/or block diagrams of apparatuses and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

As used herein, a processor/computer, which may include one or more processors/computers, may be “configured to” perform a stated function in a variety of ways, including, for example, by having one or more general-purpose circuits perform the stated function by executing one or more computer-executable program code portions embodied in a computer-readable medium, and/or by having one or more application-specific circuits perform the stated function.

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A method comprising:
receiving transaction information associated with a mobile banking transaction, wherein the transaction is performed using a mobile device;
determining, based at least partially on the transaction information, that the mobile device is positioned at a particular location during the transaction;
determining, using a processor, that the particular location is associated with a virtual automated teller machine (ATM); and
designating the transaction for processing in accordance with one or more rules associated with the virtual ATM.

2. The method of claim 1, further comprising:
processing the transaction based at least partially on the transaction information and in accordance with one or more rules associated with the virtual ATM.

3. The method of claim 1, wherein the transaction comprises a mobile deposit transaction.

4. The method of claim 3, wherein the transaction information comprises an image of a deposit item.

5. The method of claim 4, wherein the deposit item is a physical check.

6. The method of claim 3, wherein the mobile device is a mobile capture device, and wherein the mobile capture device comprises at least one of a mobile phone, a digital camera, a portable scanner, or a component thereof.

7. The method of claim 1, wherein the transaction information comprises global positioning system (GPS) coordinates, and wherein the determining that the mobile device is positioned at the particular location during the transaction is based at least partially on the GPS coordinates.

8. The method of claim 1, wherein the transaction information comprises information associated with the location of a cell site that communicates with the mobile device during the transaction, and wherein the determining that the mobile device is positioned at the particular location during the transaction is based at least partially on the information associated with the location of the cell site.

9. An apparatus comprising:
a communication interface configured to receive transaction information associated with a mobile banking transaction, wherein the transaction is performed using a mobile device; and
a processor operatively connected to the communication interface and configured to:
determine, based at least partially on the transaction information, that the mobile device is positioned at a particular location during the transaction;
determine that the particular location is associated with a virtual ATM; and
designate the transaction for processing at the virtual ATM.

10. The apparatus of claim 9, wherein the processor is further configured to process the transaction in accordance with one or more rules associated with the virtual ATM.

11. The apparatus of claim 9, wherein the transaction comprises a mobile deposit transaction.

12. The apparatus of claim 11, wherein the transaction information comprises an image of a deposit item.

13. The apparatus of claim 12, wherein the deposit item is a physical check.

14. The apparatus of claim 11, wherein the mobile device is a mobile capture device, and wherein the mobile capture device comprises at least one of a mobile phone, a digital camera, a portable scanner, or a component thereof.

15. The apparatus of claim 9, wherein the transaction information comprises global positioning system (GPS) coordinates, and wherein the determining that the mobile device is positioned at the particular location during the transaction is based at least partially on the GPS coordinates.

16. The apparatus of claim 9, wherein the transaction information comprises information associated with the location of a cell site that communicates with the mobile device during the transaction, and wherein the determining that the mobile device is positioned at the particular location during the transaction is based at least partially on the information associated with the location of the cell site.

17. A computer program product comprising:
a non-transitory computer readable medium comprising a set of codes for causing a computer to:
receive transaction information associated with a mobile banking transaction, wherein the transaction is performed using a mobile device;
determine, based at least partially on the transaction information, that the mobile device is positioned at a particular location during the transaction;
determine that the particular location is associated with a virtual ATM; and
designate the transaction for processing at the virtual ATM.

18. The computer program product of claim 17, wherein the set of codes further causes a computer to process the transaction in accordance with one or more rules associated with the virtual ATM.

19. The computer program product of claim 17, wherein the transaction comprises a mobile deposit transaction.

20. The computer program product of claim 19, wherein the transaction information comprises an image of a deposit item.

21. The computer program product of claim 20, wherein the deposit item is a physical check.

22. The computer program product of claim 19, wherein the mobile device is a mobile capture device, and wherein the mobile capture device comprises at least one of a mobile phone, a digital camera, a portable scanner, or a component thereof.

23. The computer program product of claim 17, wherein the transaction information comprises global positioning system (GPS) coordinates, and wherein the determining that the mobile device is positioned at the particular location during the transaction is based at least partially on the GPS coordinates.

24. The computer program product of claim 17, wherein the transaction information comprises information associated with the location of a cell site that communicates with the mobile device during the transaction, and wherein the determining that the mobile device is positioned at the particular location during the transaction is based at least partially on the information associated with the location of the cell site.

25. A method comprising:
receiving transaction information associated with a mobile banking transaction, wherein the transaction is performed using a mobile device;
determining, based at least partially on the transaction information, that the mobile device is positioned at a particular location during the transaction;
determining, using a processor, that the particular location is associated with a virtual ATM; and
processing the transaction based at least partially on the transaction information and in accordance with one or more rules associated with the virtual ATM.

26. The method of claim 25, wherein the transaction comprises a mobile deposit transaction.

27. The method of claim 26, wherein the transaction information comprises an image of a deposit item.

28. The method of claim 27, wherein the deposit item is a physical check.

29. The method of claim 26, wherein the mobile device is a mobile capture device, and wherein the mobile capture device comprises at least one of a mobile phone, a digital camera, a portable scanner, or a component thereof.

30. The method of claim 25, wherein the transaction information comprises global positioning system (GPS) coordinates, and wherein the determining that the mobile device is positioned at the particular location during the transaction is based at least partially on the GPS coordinates.

31. The method of claim 25, wherein the transaction information comprises information associated with the location of a cell site that communicates with the mobile device during the transaction, and wherein the determining that the mobile device is positioned at the particular location during the transaction is based at least partially on the information associated with the location of the cell site.
